(19) United States
(12) Patent Application Publication
(10) Pub. No.: US 2007/0016777 A1
(43) Pub. Date: Jan. 18, 2007

(54) Method of and system for biometric-based access to secure resources with dual authentication

(76) Inventors: James D. Henderson, Delray Beach, FL (US); Paul A. Windebank, Fort Lauderdale, FL (US)

Correspondence Address: LAW OFFICE OF DAVID H. JUDSON, 15950 DALLAS PARKWAY, SUITE 225, DALLAS, TX, 75248, US

(21) Appl. No.: 11/177,064

(22) Filed: Jul. 8, 2005

(51) Int. Cl. H04L 9/00

(52) U.S. Cl. 713/169

(57) ABSTRACT

A biometric-based access mechanism implements a dual authentication scheme. It is assumed that an authorized user has enrolled in the system by generating a set of biometric data from which at least first and second templates have been generated and stored in an authentication server. When the user at a client later seeks to obtain access to a protected resource (e.g., a data file, a database, an application, or the like) stored on an application server or other host, a new set of biometric data is generated at the client, together with new templates. The templates are generated using the same functions that were used to generate the first and second templates during the enrollment process. The client maintains one of the two templates in-memory at a client while at least one other template is exported to the authentication server for matching. If the authentication server matches the template received from the client, the authentication server exports to the client a template that must then be matched with the template being held in-memory before authentication is complete and access to the protected resource at the application server or other host provided. This “dual authentication” approach prevents a third party from spoofing the communications between the client and authentication server.

### BACKGROUND OF THE INVENTION

1. Technical Field

The present invention relates generally to methods of and systems for managing access to protected resources by authorized users in a distributed computing environment.

2. Description of the Related Art

Biometric-based access to secure resources over a computer network is a well-defined art. Typically, a user desiring access to a secure resource is first enrolled in the system and assigned a username and password. Biometric-based access is added through additional enrollment processes. During such biometric enrollment, a biometric capture device (e.g., a fingerprint reader, voice scan, or the like) obtains an image of the desired physical characteristic, which is then processed into a “template” through one or more conventional data processing techniques, which may be proprietary. The username, password and template are then stored in a database. When the user later desires access to a protected resource, he or she logs on (with the username/password pair) and re-presents his or her physical characteristic to the biometric device. If the user is authorized (through the username and password) and authenticated (by comparing the current template with the stored template), access to the protected resource is permitted. Such systems may also use the biometric mechanisms to facilitate frequent or access-based user password modifications for enhanced security. A representative system of this type is described in U.S. Pat. No. 6,636,973.

While biometric-based access control works well, there remains a need in the art to enhance such systems, especially where additional levels of security are desired or required for the particular resource. The present invention addresses this need.

### BRIEF SUMMARY OF THE INVENTION

A biometric-based access mechanism of the present invention implements a dual authentication scheme. According to the present invention, it is assumed that an authorized user has enrolled in the system by generating a set of biometric data from which at least first and second templates have been generated and stored in an authentication server. When the user at a client later seeks to obtain access to a protected resource (e.g., a data file, a database, an application, or the like) stored on an application server (or other host), a new set of biometric data is generated at the client, together with new templates. The templates are generated using the same functions that were used to generate the first and second templates during the enrollment process. The client maintains one of the two templates in-memory at a client while at least one other template is exported to the authentication server for matching. If the authentication server matches the template received from the client, the authentication server exports to the client a template that must then be matched with the template being held in-memory before authentication is complete and access to the protected resource at the application server provided. This “dual authentication” approach prevents a third party from spoofing the communications between the client and authentication server in a manner that might otherwise allow the third party to gain access to a template from which a false authentication decision can be manufactured.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram illustrating a representative distributed computing environment in which the present invention may be implemented;

FIG. 2 illustrates a set of software components that facilitate the dual authentication scheme of the present invention;

FIG. 3 is a process flow illustrating a preferred embodiment of the present invention; and

FIG. 4 illustrates how a biometric capture device and associated software generate first and second templates from a given data set generated by the capture device.

### DETAILED DESCRIPTION OF THE PREFERRED EMBODIMENT

For purposes of illustration, the present invention is shown as being implemented in a distributed computer environment within a given enterprise. The invention may be implemented as a product or a service. A representative system in which the invention is implemented comprises an application server 102 (or any other host), a client machine 104, and an authentication server 108. The authentication server 108 has an associated administrative console 110. The machines are connected to one another over a network, such as wide area network (WAN), local area network (LAN), protected network (e.g., VPN), a dedicated network, or some combination thereof. Communications among the various machines are assumed to be encrypted or otherwise protected, e.g., via SSL or the like. One or more of the machines preferably are located behind an enterprise firewall. The application server (and there may be more than one) supports a given resource 100 (a file, a database, a file system, an application, a computer, a system, or the like) to which a user of the client machine 104 desires to access. In one illustrated embodiment, the resource is a process executing on the application server 102. It is assumed that the user of the client machine has been authorized to access the resource (e.g., by an enterprise administrator or the like). The client machine has an associated biometric capture device 106. Biometric capture device 106 generates a biometric data set for a given physical characteristic, such as fingerprint, facial geometry, voice print, retinal scan, typing speed, or any other characteristic that distinguishes one person from another. Such devices include software routines for processing the biometric data set into a “template,” which is a digital representation of the biometric data. The administrative console 110 may also include a biometric capture device 112. In a representative embodiment, the application server 102 and the authentication server 108 are both IBM iSeries machines running an operating system (e.g., IBM i5/OS), and the client machine 104 is a workstation having commodity hardware (e.g., Pentium class processor(s)), operating system (Windows, Linux, or the like), application programs (e.g., Internet Explorer, and the like) and utilities. The authentication server 108 comprises a web server 114 (e.g., Apache) and a database 116 (e.g., IBM DB2). A representative biometric capture device 106 or 112 is a fingerprint sensor Model AES3500 (utilizing an RF electronic imaging mechanism called TruePrint technology) manufactured by AuthenTec, Inc. Of course, any other hardware, software, systems, devices and the like may be used. More generally, the present invention may be implemented with any collection of autonomous computers (together with their associated software, systems, protocols and techniques) linked by a network or networks.

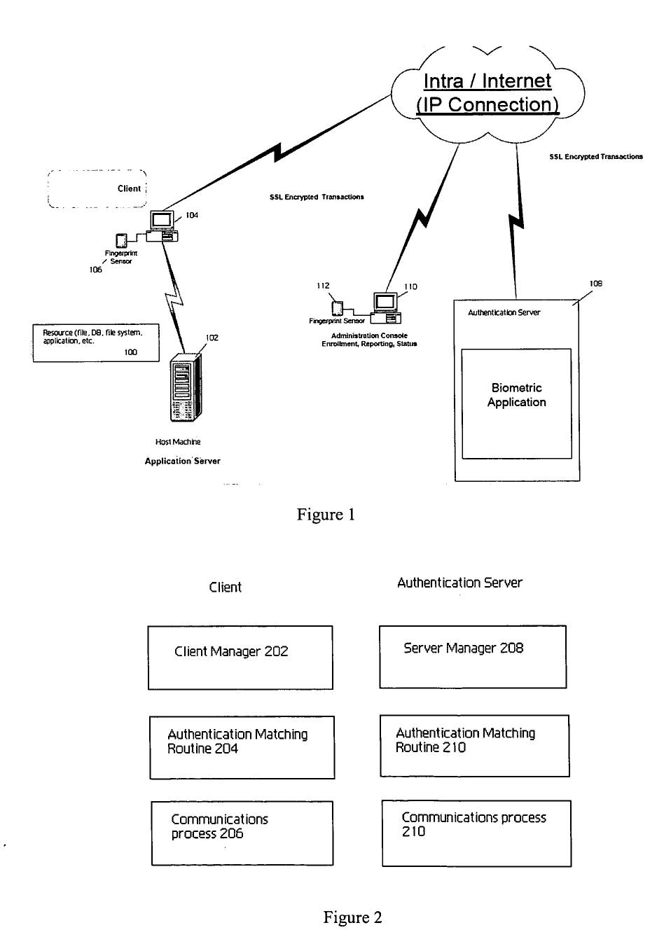

As illustrated in FIG. 2, the present invention comprises a set of preferably software-based functions (e.g., applications, processes, execution threads, or the like) or firmware-based functions that provide the dual authentication scheme. As shown in FIG. 2, these functions are provided in a set of components supported across the client machine and the authentication server. These components comprise, on the client machine, a client manager 202, an authentication matching routine 204, and Web servlet 206, and, on the authentication server, a server manager 208, an authentication matching routine 210, and Web servlet 212. These functions may be integrated into one set of code, but this is not a requirement. Neither the authentication matching nor the communications functions are required to be native to the dual authentication codebase, as the matching function may be provided with the biometric capture device (e.g., as a software driver), and communications (e.g., through the servlet) may comprise part of an underlying application server framework. A representative application server is IBM WebSphere Application Server (WAS), such as Version 5.0 or greater, which uses JVM (Java Virtual Machine) 1.3.1 and is J2EE-compliant. Thus, according to the invention, each client and each authentication server include a manager process and template matching software. The manager process may be implemented in native code, as an execution thread, or in any other convenient manner depending on the client-server architecture, storage or processing constraints, or the like. The particular hardware and software implementation details are not part of the present invention.

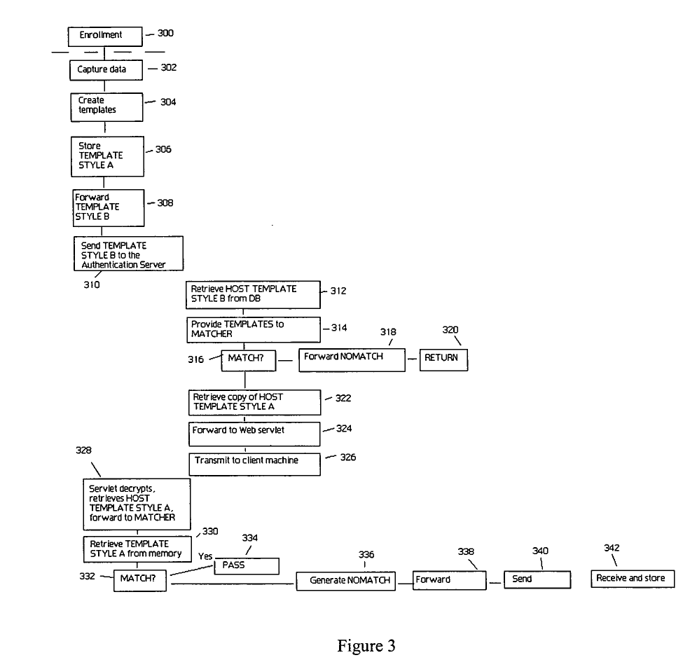

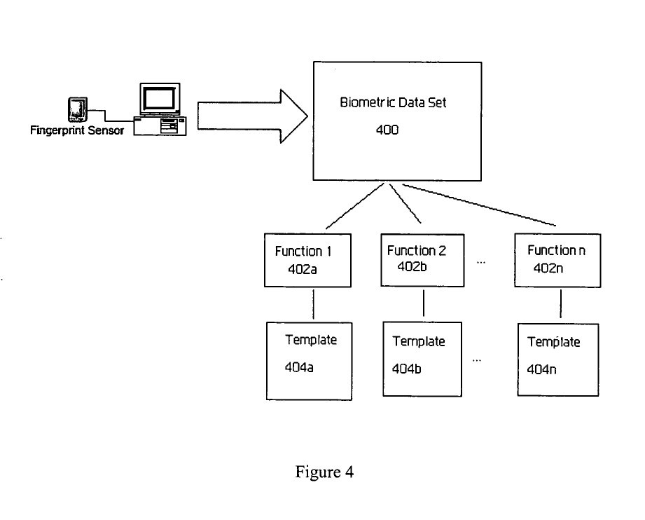

As illustrated in FIG. 4, a biometric capture device generates a biometric data set 400 that, according to the present invention, is first processed by a set of two or more processing functions 402a-n into a set of two or more templates 404a-n. The processing functions 402 typically are proprietary algorithms created by the providers of the biometric devices, but one or more commercially available or open source techniques may be used. By way of a simple example, one processing function generates a simple MD5 hash of a portion of the biometric data set while a second processing function generates a SHA-1 hash of the portion. For purposes of the present invention, the particular processing functions are not critical; rather, what is important is that at least first and second processing functions operate on the same biometric data set (or portions thereof) to generate the at least first and second templates, and that the same first and second processing functions be used during a user's enrollment process and when the user seeks to access a protected resource using the inventive dual authentication scheme. Generalizing, it is assumed that a given biometric data set processes at least two (2) biometric templates each with unique differentiating characteristics. In a representative embodiment, the fingerprint sensor is the AuthenTec AES3500 device (or equivalent) that has associated therewith software (e.g., in the form of a dynamic link library, DLL) that implements the algorithms for generating the templates. Calls to the DLL may be implemented through an application programming interface (API). The templates are stored in a protected manner in the authentication server's database. Although not meant to be limiting, preferably the database server implements a database management scheme with a user's enrollment data indexed by a data identifier. The identifier is associated with a data record that is encrypted. Each field in the data record includes data associated with a given one of the templates, and preferably a field level encryption scheme is applied across the data record for enhanced security. With the above as background, the dual authentication scheme is not described in detail using the process flow diagram shown in FIG. 3.

As described above, it is assumed that the authentication server runs an AUTHENTICATION HOST process. The process begins at step 300 with enrollment. At this step an AUTHENTICATION HOST process of the authentication server receives and stores two (2) biometric templates with unique differentiating characteristics, as has been described above with respect to FIG. 2. The first template is the HOST TEMPLATE STYLE A and the second template is the HOST TEMPLATE STYLE B. Preferably, the authentication stores these templates in an encrypted database, although this is not required. It is now assumed that a user desires to access a protected resource, such a resource 100 stored on the application server 102 shown in FIG. 1. For purposes of illustration, it is assumed that the user is making the access request from the client 104 having the biometric capture device 106, also as illustrated in FIG. 1. Of course, the user may enroll his or her biometrics at a first client and then request access to a protected resource from a second client. After the user logs in and is authorized in the usual manner (e.g., by entry and verification of the user's username and password), the routine continues at step 302. At this step, and when prompted for authentication, the user responds by providing the requested BIOMETRIC DATA via the capture device. At step 304, just as during the enrollment process, preferably two (2) sets of BIOMETRIC DATA, each with unique differentiating characteristics, are constructed, namely, TEMPLATE STYLE A and TEMPLATE STYLE B. Of course, any number of TEMPLATE STYLES may be generated, depending on the number generated during the enrollment process. Also, one of ordinary skill in the art will appreciate that the first and second processing functions used to generated the TEMPLATE STYLES A and B (and so on) must be the same processing functions used to generate the respective HOST TEMPLATE STYLES A and B (and so on). At step 306, TEMPLATE STYLE A is stored in-memory at the client and, at step 308, TEMPLATE STYLE B is sent to a communications (e.g., Web servlet) process executing on the client. Of course, here the nomenclature A and B is used for illustration only; it is only required that the particular version maintained in-memory or sent, as the case may be, be identifiable so that the authentication match can be performed at the authentication server 108 of FIG. 1.

At step 310, the client communications process transmits TEMPLATE STYLE B to the AUTHENTICATION HOST process executing on the authentication server; preferably, this transmission occurs over a secure link. Alternatively, TEMPLATE STYLE B may be encrypted prior to being forwarded from the client to the authentication server. The routine then continues at the authentication server. At step 312, the authentication server communications process retrieves HOST TEMPLATE STYLE B from its associated database 110 of FIG. 1 and, at step 314, provides TEMPLATE STYLE B (received from the client) and HOST TEMPLATE STYLE B (retrieved from the local database) to a HOST AUTHENTICATION MATCHER process executing on the authentication server. Preferably, a MATCHER process is instantiated for each authentication request received at the authentication server. At step 316, the HOST AUTHENTICATION MATCHER tests to determine whether TEMPLATE STYLE B matches HOST TEMPLATE STYLE B within a given, first acceptance criteria. The particular criteria, of course, will depend on the processing function that was used to generate the template. An administrator may establish one or more different acceptable thresholds, depending on the level(s) of security desired or required. If the outcome of the test at step 316 indicates that there is no match between TEMPLATE STYLE B and HOST TEMPLATE STYLE B, the routine branches to step 318, wherein the authentication server forwards a NOMATCH message to the authentication server's communications process. At step 320, the authentication server's communications process returns the NOMATCH message to the requesting client and the authentication process terminates. If, however, the outcome of the test at step 316 indicates that there is an acceptable match between TEMPLATE STYLE B and HOST TEMPLATE STYLE B, the routine continues at step 322 with the AUTHENTICATION HOST process of the authentication server retrieving a copy of HOST TEMPLATE STYLE A from its database, which it then may encrypt. At step 324, the AUTHENTICATION HOST process provides the copy of HOST TEMPLATE STYLE A, together with an indication of the match, to the authentication server's communications process. At step 326, the authentication server's communications process sends this information to the requesting client's communications process.

Processing then continues back at the client. At step 328, the client communications process decrypts the data, retrieves HOST TEMPLATE STYLE A and forwards it to a local MATCHER process. At step 330, the client Web servlet retrieves TEMPLATE STYLE A (which to this point has been maintained in-memory at the client) and forwards it to the MATCHER process. At step 332, the client MATCHER process performs a test to compare TEMPLATE STYLE A and HOST TEMPLATE STYLE A, i.e., to determine whether these templates match within a given second, acceptance criteria. Once again, the particular acceptance criteria will depend on the processing function that was used to generate the template. An administrator may establish one or more different acceptable thresholds, depending on the level(s) of security desired or required. Also, the acceptable threshold may be varied as a function of the “closeness” in the TEMPLATE B biometric comparisons, or based on some other condition or occurrence. If the outcome of the test at step 332 indicates that there is a match between TEMPLATE STYLE A and HOST TEMPLATE STYLE A within the given acceptance criteria, the routine continues at step 334, which indicates a PASS. At this point, the user is provided access to the protected resource. If, however, the outcome of the test at step 332 is negative, the routine branches to step 336, wherein a NOMATCH message is generated by the client MATCHER process. Continuing with this branch, at step 338, the NOMATCH message is provided to the client's communications process which, at step 340, sends the NOMATCH message to the authentication server. At step 342, the authentication server communications process receives the NOMATCH message and forwards it to the authentication server, which stores the indication in its associated database. This completes the processing.

Thus, as can be seen, the present invention assumes that an authorized user has enrolled in the system by generating a set of biometric data from which at least first and second templates have been generated and stored in an authentication server. When the user at a client later seeks to obtain access to a protected resource (e.g., a data file, a database, an application, or the like) stored on an application server or other host, a new set of biometric data is generated at the client, together with new templates. The client maintains one of the two templates in-memory at a client while at least one other template is exported to an authentication server for matching. If the authentication server matches the template received from the client, it, the authentication server, exports to the client a template that must then be matched with the template being held in-memory before authentication is complete and access to the protected resource provided. This “dual authentication” approach prevents a third party from spoofing the communications between the client and authentication server in a manner that might otherwise allow the third party to gain access to a template from which a false authentication decision can be manufactured.

The present invention provides scalable, enterprise biometric authentication in a manner that overcomes the deficiencies of the prior art. The dual authentication scheme works by associating biometric data with a user in a way that cannot be spoofed, i.e., regenerated by other than from the biometric capture device used to enroll the authorized user and then being later used to access the protected resource.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the network are not a limitation of the present invention. A given machine includes network interfaces and software to connect the machine to a network in the usual manner. A machine typically includes a Web browser. An application server process may provide support for servlets and the like.

A variation of the present invention would be to create the first and second templates (either during enrollment or in use to access a protected resource) using the same codebase (e.g., a single processing function) applied to two distinct portions of the biometric data set.

Having described our invention, what we now claim is set forth below.

1. A method to manage access to a given resource by an authorized user in a distributed computing system, the system including a client having an associated biometric capture device, and an authentication server in which are stored first and second templates derived from a given biometric characteristic of the authorized user by applying first and second functions to a biometric data set, the method comprising:
upon a given request to access the given resource, generating, at the client, third and fourth templates by re-applying the respective first and second functions to a biometric data set that is generated at the client contemporaneously;
forwarding the third template to the to the authentication server while maintaining the fourth template in-memory at the client;
determining, at the authentication server, whether the third template matches the first template within a first acceptance criteria;
if the third template matches the first template with the first acceptance criteria, forwarding an indication of the match and the second template from the authentication server to the client;
determining, at the client, whether the second template forwarded from the authentication server matches, within a second acceptance criteria, the fourth template with then held in-memory;
if the second template matches the fourth template within the second acceptance criteria, enabling access to the given resource by the authorized user.

2. The method as described in claim 1 further including the step of inhibiting access to the given resource if the third template does not match the first template within the first acceptance criteria, or if the second template does not match the fourth template within the second acceptance criteria.

3. The method as described in claim 1 wherein communications between the authentication server and the client are provided over a secure link.

4. The method as described in claim 4 wherein each communication is encrypted.

5. The method as described in claim 1 wherein the client and the authentication server communicate over a wide area network, local area network, or private network.

6. The method as described in claim 1 wherein the resource is stored on an application server or other machine distinct from the authentication server.

7. The method as described in claim 6 wherein the authentication server manages access requests from a set of authorized users in an enterprise.

8. A biometric-based access method operative in a distributed networking environment comprising a client machine having a biometric capture device, an authentication server, and an application server or other host having a protected resource, wherein at least first and second templates generated from a biometric data set have been stored in or in association with the authentication server, comprising:
upon an access request at the client machine, generating a new set of biometric data and associated third and fourth templates;
maintaining the third template in-memory at the client machine while exporting the fourth template to the authentication server where it can be matched against the second template;
upon any receipt at the client machine of the first template, allowing access to the protected resource if the first template matches the third template.

9. The biometric-based access method as described in claim 8 wherein communications between the client machine and the authentication server occur over a secure link.
